(19) United States
(12) Patent Application Publication
(10) Pub. No.: US 2013/0145399 A1
(43) Pub. Date: Jun. 6, 2013

(54) PERSONAL TELEVISION CHANNEL

(71) Applicants: Joseph F. Wodka, Hoffman Estates, IL (US); Nitya Narasimhan, Hopewell Junction, NY (US); Aroon V. Tungare, Winfield, IL (US); Venugopal Vasudevan, Palatine, IL (US)

(72) Inventors: Joseph F. Wodka, Hoffman Estates, IL (US); Nitya Narasimhan, Hopewell Junction, NY (US); Aroon V. Tungare, Winfield, IL (US); Venugopal Vasudevan, Palatine, IL (US)

(73) Assignee: GENERAL INSTRUMENT CORPORATION, Horsham, PA (US)

(21) Appl. No.: 13/310,847

(22) Filed: Dec. 5, 2011

(51) Int. Cl. H04N 21/262; H04N 21/482

(52) U.S. Cl. 725/46; 725/97

(57) ABSTRACT

A “personal television channel” is created for a user by a television head-end server. The personal channel has its own playlist that can include, in addition to service offerings from a television-delivery service, content stored locally by the user, media sent to the user from third parties (e.g., an electronic magazine publisher), and messages from other users. The user selects the personal channel just as he would select any other television channel. He then sees a playlist for the personal channel (which may be integrated into a general electronic program guide (“EPG”) supplied by the television provider). The user selects and plays content from the playlist just as he would interact with a traditional EPG. The user can specify local content to be included in his personal channel. He can also send content to another user to be included in the playlist of the recipient's personal channel.

### FIELD OF THE INVENTION

The present invention is related generally to television-content delivery systems and, more particularly, to interactive television.

### BACKGROUND OF THE INVENTION

Industry reports show (a) that viewers are spending more time than ever watching television and (b) that the average U.S. home has more televisions than people (2.86 televisions for 2.5 people in 2011). These reports lead to the conclusion that the television is one of the most pervasively visible displays in the home, from the user's perspective.

Taking advantage of this prominence of television, modern television sets (and their associated set-top boxes) are beginning to provide interactive and social applications in addition to the traditional “content-consumption” experiences (e.g., broadcast television programming). For example, a television screen can show an interactive user interface overlaid onto the television's traditional broadcast content, the user interface supporting an application that complements the broadcast content (e.g., an interactive sports interface overlaid onto a sports network feed).

In another example, users are beginning to receive media presentations from sources other than their television-service provider. (Here, “media presentations” generally include just about any kind of digital content, and, more specifically, sound, video, and interactive files.) The television screen becomes yet another display, in addition to the displays of home computers, smart telephones, and other user devices, for this content and for web-based user applications. For some of these applications, content is “pulled down” when requested for display on the television. In more sophisticated applications, third-party web providers “push” content down to a television that supports a fully bidirectional interaction.

While traditional passive television programming, interactive-television services, and web-based services may all be presented on the same television screen, this can actually frustrate users because the command and control interfaces used to interact with these different types of content differ so dramatically from one another.

### BRIEF SUMMARY

The above considerations, and others, are addressed by the present invention, which can be understood by referring to the specification, drawings, and claims. The present invention allows users to access media from many sources by using a single, unified interface that mimics the functionality of the familiar television channel-selection interface.

A “personal television channel” is created for the user by a television head-end server. The personal channel has its own playlist that can include, in addition to service offerings from a television-delivery service, content stored locally by the user, media sent to the user from third parties (e.g., an electronic magazine publisher), and messages from other users. The user selects the personal channel just as he would select any other television channel. He then sees a playlist for the personal channel (which may be integrated into a general electronic program guide (“EPG”) supplied by the television provider). The user selects and plays content from the playlist just as he would interact with a traditional EPG.

The user can specify local content to be included in his personal channel. He can also send content to another user to be included in the playlist of the recipient's personal channel. If the recipient's device (e.g., a set-top box) is located in the same house with the sender's device (they may even be the same device supporting multiple personal channels for various people in the same household), then the content can be sent directly without involving the head-end.

When sending content, the sender can specify a delivery criterion, such as “do not let the recipient watch this before a specified time,” “assign a priority to this content,” “delete this content after a certain number of viewings,” “deliver this content only after the recipient has satisfied a specified criterion,” and the like.

The head-end server can ensure that personal-channel content is available when the user selects it by trickle casting the content to the user's local storage device (e.g., a DVR) before making the content visible on the playlist.

To ease the process of adding content to a personal channel, a proxy server can be established on the web. Then any device with access to the web can send content to the proxy server and address that content to a personal channel. The proxy server ensures delivery to the appropriate head-end server, after performing any necessary translations. It is contemplated that the web interface of the proxy server makes it easier to send content via the proxy server rather than sending the content directly to a head-end server.

It is contemplated that at least some of the content on the personal channel will be copyrighted. To protect the content provider's interests, digital-rights-management (“DRM”) techniques are implemented on the client device, on the head-end server, and on the proxy server.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of some of the devices shown in FIG. 1;

FIG. 3 is a flowchart of a representative method for a head-end server to deliver content via a personal television channel;

FIG. 4 is a flowchart of a representative method for a client device to present a personal television channel to its user; and

FIG. 5 is a flowchart of a representative method for a proxy server that transports content for a personal television channel.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

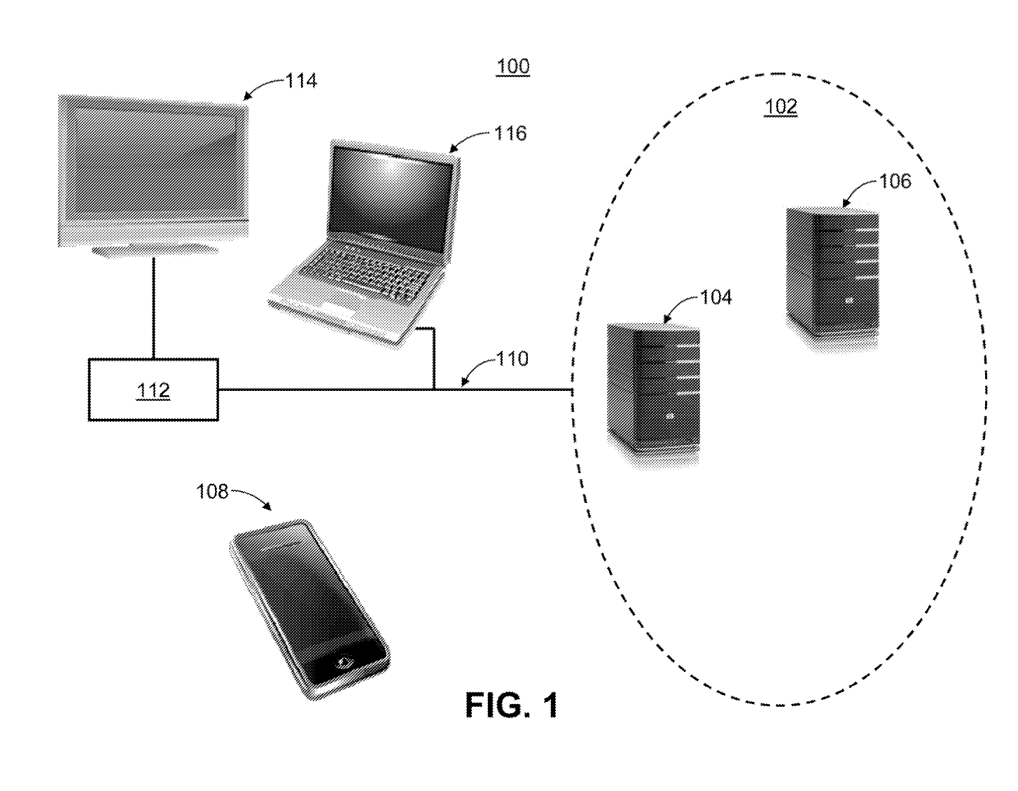

Aspects of the present invention may be practiced in the representative communications environment 100 of FIG. 1. Connected together via any or all of various known networking technologies 102 are servers such as head-end servers 104 and proxy servers 106. For ease of illustration, only one of each type of server 104, 106 is shown, but multiples of each can exist and can work together, as discussed below.

Head-end servers 104 (and, indirectly, proxy servers 106) provide, via the networking technologies 102, media-download and personal television services to end-user devices. One example of an end-user device is a cellular telephone 108. This telephone 108 communicates wirelessly to a wireless base station (not shown but known in the art) to access the public switched telephone network, the Internet, or other networks to access the services provided by the head-end server 104.

Non-wireless end-user devices are supported by “wireline” network technologies (e.g., fiber, wire, and cable) 110. For example, a set-top box 112 generally receives television programming from a head-end server 104 and provides a user interface (e.g., an interactive program guide) for selecting and viewing content from the head-end server 104. A digital video recorder (not shown) can store programming for later viewing. Video content may be viewed on a television monitor 114. In some situations, a laptop computer 116 accesses web-based services either wirelessly or via the wireline network 110. A home gateway, kiosk, digital sign, or media-restreaming device (not shown) are other possible end-user devices.

(A media-restreaming device transfers content between disparate types of networks. For example, it receives content from a cable system 110 and then transmits that content over a local radio link such as WiFi to the cellular telephone 108. The media-restreaming device usually operates in both directions to carry messages between the networks. In some embodiments, aspects of the present invention are practiced by a media-restreaming device.)

Of particular interest to the present discussion is the head-end server 104. In general, the head-end server 104 provides traditional broadcast and video-on-demand (“VOD”) content to the end-user devices such as the set-top box 112. In addition, the head-end server 104 receives personal media content (possibly from user devices and from third-party providers), packages that content into a personal television channel, and delivers the personal channel to the set-top box 112. The set-top box 112 presents the personal channel to a user in the same way that it presents traditional broadcast television channels. The user can thus access all kinds of content using this familiar interface.

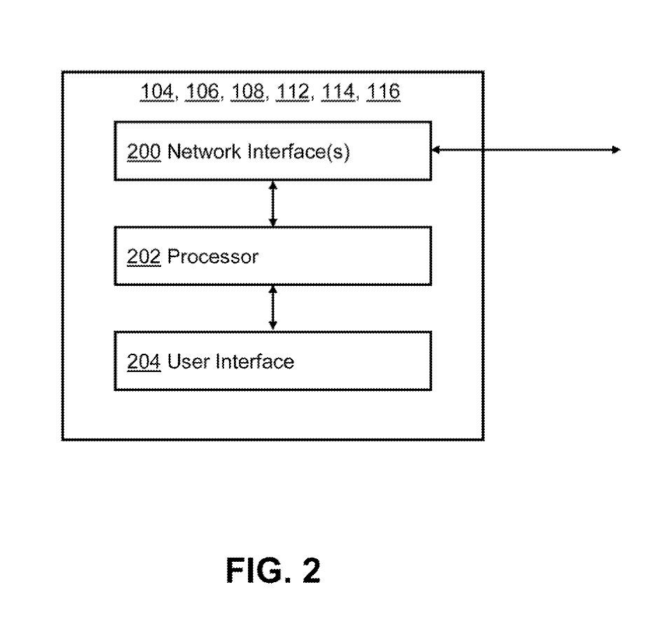

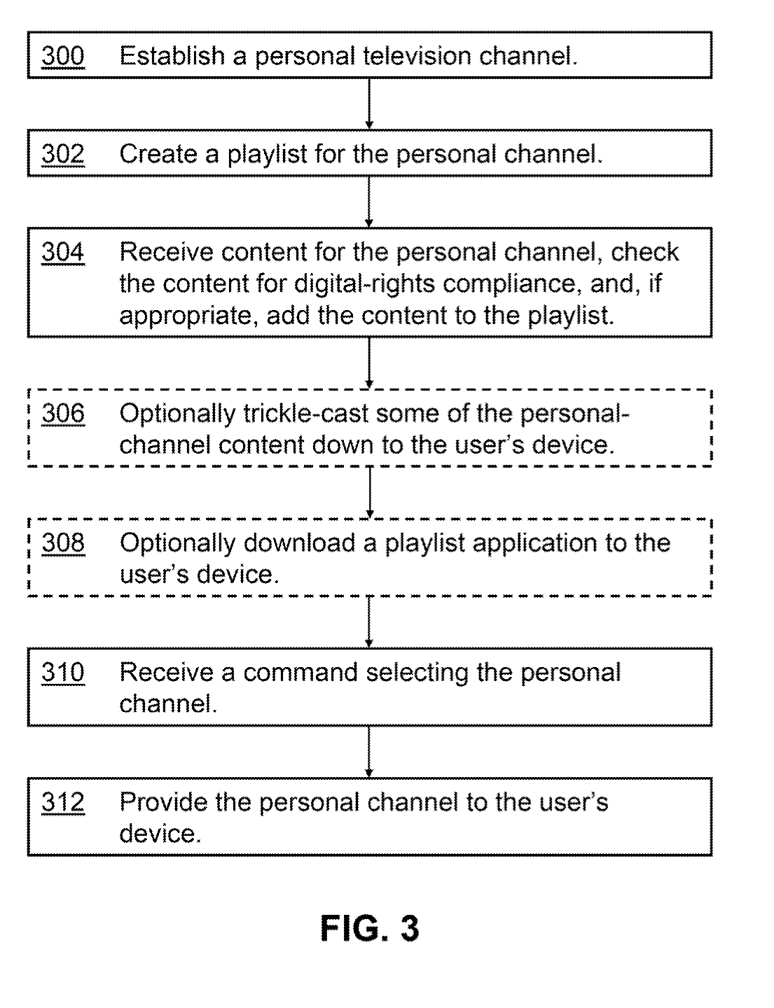

FIG. 2 shows the major components of a representative head-end server 104, proxy server 106, or end-user device 108, 112, 114, 116. Network interfaces 200 send and receive media presentations, related information, download requests, and, in particular, content for the personal television channel. A processor 202 controls the operations of the device and, in particular, supports aspects of the present invention as illustrated in FIGS. 3 through 5, discussed below. The user interface 204 supports a user's (or administrator's) interactions with the device. Specific uses of these components by specific devices are discussed as appropriate below.

The head-end server 104 can apply the representative method of FIG. 3. In step 300, the head-end server 104 establishes a personal television channel. Generally, the head-end server 104 dedicates a channel number to be used when the user wishes to access this personal channel. The personal channel may be tied to a particular end-user device, such as the set-top box 112, so that anyone in the household can access the channel. Alternatively, authentication can be established so that only an authorized user can access the personal channel. In this way, a single set-top box 112 may support several personal channels in one household, and each channel would be accessed through an authentication and sign-in process. If a channel is associated with a particular person (or, equivalently, with a particular authenticator), then the personal channel can “move” from place to place as the authorized user accesses via any number of end-user devices, possibly located at different locations.

In step 302, the head-end server 104 creates a playlist of the content available through the personal channel. Once created, the playlist is updated as content is added or removed.

The head-end server 104 adds content to the playlist in step 304, thus making that content available through the personal channel.

The content can include traditional television content, such as broadcast programming and VOD. By adding such content to the personal channel, a user makes this content more easily accessible to him so he can access it readily, rather than having to wade through all the offerings available through traditional means. If the user regularly watches three different broadcast programs delivered on three traditional channels, for example, then he can add those three programs to his personal channel and access them all in that one place.

Even though the personal channel can accommodate traditional content, the content provider may restrict the use of its content in any of a number of ways. For example, VOD content is generally available only under contract for a fee, and that contract only allows access for a certain period of time or for a certain number of viewings. Embodiments of the personal channel allow for this, presenting a payment screen when the user wishes to add VOD content to the personal channel and removing the VOD content from the personal channel's playlist upon expiration of the contract. As another restriction on availability, normal broadcast content, while available to subscribers without any payment in addition to the monthly subscription fee, is generally only available for certain time. Embodiments of the personal channel do not attempt to violate such restrictions.

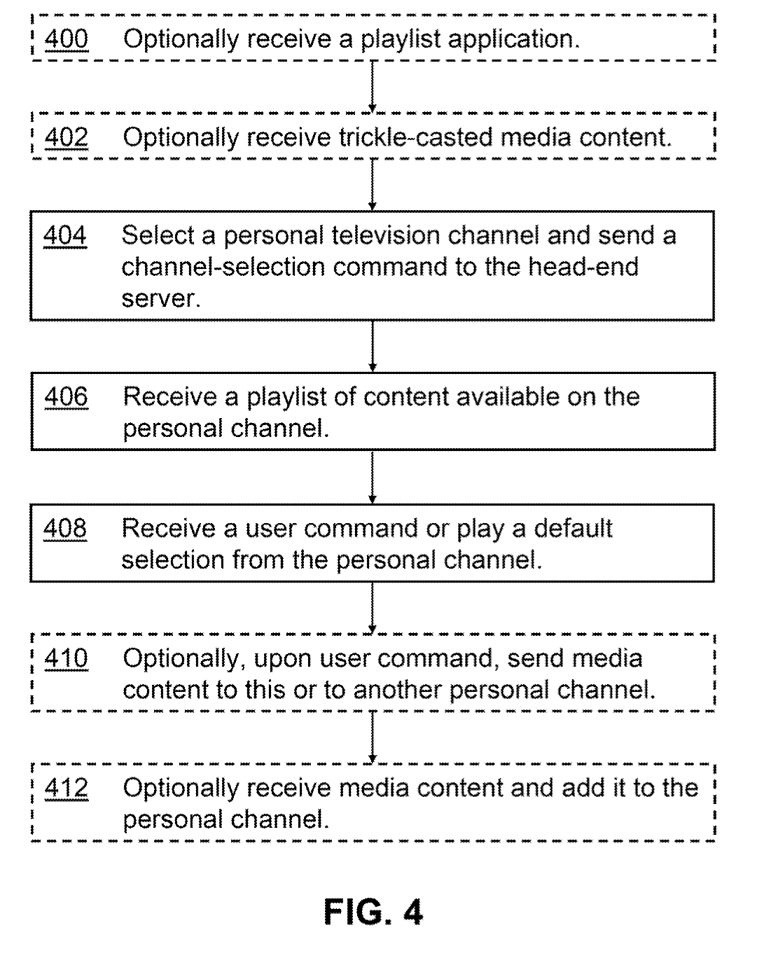

The head-end server 104 can receive content, regardless of its type, from any number of separate sources in step 304. As discussed below in reference to FIG. 4, a user of a personal channel can upload locally stored content, such as holiday photographs or videos, to the head-end server 104 for inclusion in his personal channel. He can also send such content to another personal channel, as, for example, a way to provide a video of a child's dance recital to the grandparents on their own personal television channel.

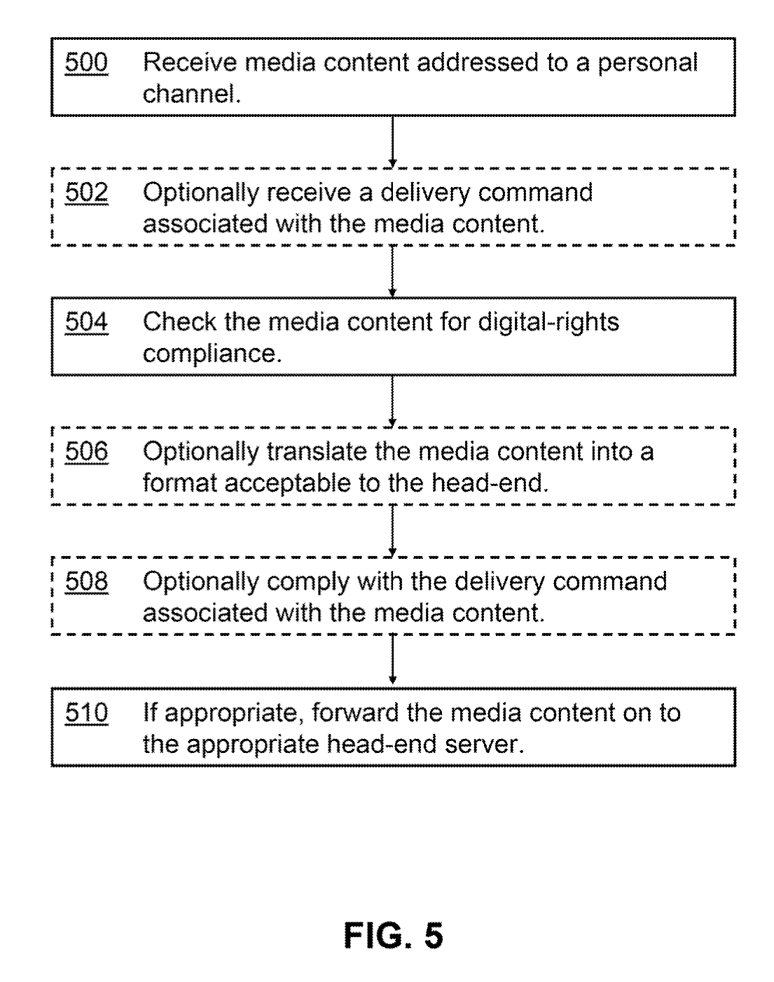

The head-end server 104 can also accept content from a third-party publisher (e.g., a commercial entity not associated with the television-subscription service). The user may subscribe to a digital magazine that is delivered monthly to his personal channel., for example. The personal channel provides an appropriate interface for such content, especially when the magazine includes videos. (The third party generally delivers the content to the head-end server 104 by means of a proxy server 106, discussed below in reference to FIG. 5.)

All content, of whatever source, can be checked for compliance with the digital-rights policy of its publisher in step 304 before that content is made available on the personal channel. By centralizing digital-rights management on the head-end server 104, a robust digital-rights environment is created. It is expected that publishers will readily allow their content to be added to personal television channels.

In step 306, the head-end server 104 trickle-casts some content down to the end-user device (e.g., a DVR) associated with the personal television channel. While optional, this is important because television-content distribution systems (e.g., the cable system 110) have a limited amount of bandwidth available to spend on personal content. If content is constantly trickled down whenever bandwidth is available, it is much more likely that the user will be able to access the content immediately when he chooses to do so. Because trickle casting does not demand a large amount of guaranteed bandwidth, in some embodiments, the head-end server 104 uses non-traditional networks for trickle casting the content, such as the Internet. A large digital magazine is a prime example of content that benefits from trickle casting.

Trickle casting a digital magazine is a good scenario for illustrating a point that potentially applies to all content. Publishers of digital magazines generally do not want each issue to be made available to subscribers before a specified “news stand” date, so that all subscribers get an issue at the same time. Rather than waiting for that date before beginning to download the digital magazine, the head-end server 104 can trickle cast the magazine before that time but not make it accessible before the official delivery date. This is accomplished by associating a “delivery criterion” with the content, in this case “do not allow access or even include on the playlist before this date.” This feature can also be used for personal content so that a birthday message, for example, is not delivered before the recipient's birthday. Other deliver criteria include “delete after a specified time” or “only allow a certain number of viewings” (both very useful for VOD content). A priority can be attached to certain content. This is especially useful when the personal channel has a limited amount of storage and must manage that storage by automatically making room for new content by deleting old content. The personal channel can also enforce a contextual delivery criterion. For example, the content only becomes available after the user has watched a particular television program or after he has performed a certain task. In similar manner, a sign-in requirement can be attached to a particular piece of content, even if the personal channel is generally available to everyone in the household without signing in.

In step 308, the head-end server 104 optionally downloads an application for interacting with the playlist for the personal television channel. This application runs on an end-user device such as the set-top box 112. The application can be made to look and operate just like the EPG guide generally provided for traditional content and can even be integrated into the EPG so that this application is brought up when the user “tunes” to the personal television channel. Alternatively, this application can be specifically optimized for the types of media presented on the personal channel.

In step 310, the head-end server 104 is informed that a user has elected to view the personal television channel, and the head-end server 104 begins to provide that channel in step 312. In some embodiments, when the personal channel is selected, it immediately displays its own EPG. Content is rendered when the user requests it. Other embodiments more closely mimic traditional television channels, and the personal channel, as soon as it is selected, begins to render some of its content to the user. For other options, see the discussion below of step 408 of FIG. 4.

The method of FIG. 3 (and also the methods of FIGS. 4 and 5) is not meant to be followed in any kind of rigid order. Rather all of the steps can be constantly or repeatedly invoked as content is received by the head-end server 104, added to the playlist, rendered to the user at the user's discretion, and deleted or replaced by other content.

FIG. 4 presents a method for a representative end-user device, e.g., the set-top box 112, that supports a personal television channel. In step 400, the end-user device 112 optionally receives an EPG application for the personal channel (sent in step 308 of FIG. 3 and discussed above).

In step 402, the end-user device 112 optionally receives trickle-casted content (sent in step 306 of FIG. 3). This content can be stored on a local DVR.

The user selects the personal channel in step 404 using any of techniques known for selecting traditional broadcast television channels. Generally, the head-end server 104 is informed of this selection. If, however, connection is temporally lost with the head-end server 104, then the end-user device 112 can proceed with the method of FIG. 4 but only rendering locally stored content to its user.

The end-user device 112 retrieves a playlist of the content available on the personal channel in step 406 and optionally presents an EPG to the user. As in the previous step, this generally involves communication with the head-end server 104 but can proceed, to a limited extent, if that connection is temporally unavailable.

The end-user device 112 either responses to a user's command in step 408 to play content, or the device 112 begins to play some content from the playlist. This latter mode is meant to mimic traditional broadcast television where a user tunes to a channel and immediately begins to see the content being played.

If end-user device 112 selects content from the playlist, there are several factors that can influence the selection. Simplistically, the first piece of content listed can be played. In other situations, the present context of the viewer is analyzed and compared to any contextual delivery criteria attached to content on the playlist (see the discussion above in reference to step 306 of FIG. 3). If the current context satisfies the contextual delivery criterion of a specific piece of content, then that content may be selected for viewing in step 408. Even without an explicit contextual delivery criterion, the end-user device 112 may choose to select content that is somehow related to the user's current context or to his recent activities on this or another end-user device. If, for example, the user has been watching a sports program before tuning to the personal channel, then sports content may be preferentially selected. If, on the other hand, the user just viewed a message from a friend on his cell phone 108, and if the end-user device 112 knows this, then the end-user 112 may choose to select from the playlist a video message from that friend. The selection in step 408 can also be based on the type of device that the user is currently watching: A video clip may be selected if the user is watching the large-screen television 114, while a still photograph or text message may be selected if the user is watching the smaller screen on his cell phone 108. Regardless of the end-user device's selection in step 408 (if any), the user can easily override that selection and choose to watch something else.

Because the playlist of the personal channel is specific to this user (or to this end-user device 112), the user can be given, in some embodiments, many more options in step 408 for interacting with the EPG. For example, the user can rearrange selections on the playlist, remove content from the playlist, and even enable a random-play mode of delivery. The user can filter content so that some of the available content is not displayed on the EPG (although that content remains on the playlist). The user can add a delivery priority to a content item or schedule a content item for playing at a particular time. The user can bind multiple items of content together into one content item. In some instances, the user may wish to set an interruptibility criterion so that he is not interrupted with messages about, say, incoming content until he has finished viewing the current content item.

The user can add his own content to his own personal channel in step 410 or can send content to another personal channel. This will usually involve uploading the content to the head-end server 104.

If the sending and receiving end-user devices are located closely together (e.g., in the same room), then the content can be sent from one device directly to the other without passing through the head-end server 104. However, this direct-transfer scenario has the potential for violating the digital-rights policy of commercial content. (Of course, one user can send content that he owns, such as his snapshots or home videos, to anyone he cares to.) To protect those rights, many embodiments ensure that this direct transfer of content can only take place if the content owner approves the transfer. This can involve, for example, a message from the sender (or from the intended recipient) to the head-end server 104 identifying the content to be transferred and the intended recipient. The head-end server 104 checks the digital-rights policy for the content (possibly by sending a query to the owner of the content). If the recipient has rights to the content, then the head-end server 104 sends a digital certificate to the recipient that allows it to receive the content. The recipient's personal channel application can be written to only accept content if it is accompanied by a digital certificate provided, directly or indirectly, by the content owner. Digital certificates and their use in authorizing content distribution are well known in the art.

Note that direct transfer can be a very efficient use of the limited bandwidth provided by the cable system 110 for personal content: Only the authentication messages (which are generally very small) use the bandwidth of the cable system 110, while none of the cable system's bandwidth is used to transfer the actual content (which can be very large). This efficiency also allows direct transfer to be used by commercial entities. For example, a retailer pushes content to a user's tablet while the user is in a store (e.g., by a WiFi or Bluetooth connection). Once back at home, the user's tablet enforces the digital-rights policies for the content by contacting the head-end server 104.

If the direct transfer is not allowed, then the recipient can be given a message telling him that he is not allowed to see the content. In some scenarios (depending upon the specific digital-rights policy that applies to the content), the user may be given a “teaser” of the content, e.g., a still image when the content is a video clip or an image of the magazine cover if the content is the full digital magazine. The recipient is then given the option of upgrading his service, or buying a one-time contract, in order to receive the content.

Regardless of where the content came from, the recipient of the content adds the new content to the playlist in step 412 (unless the head-end server 104 has already done this).

FIG. 5 presents a method for a representative proxy server 106. In step 500, the proxy server 106 receives content addressed to a personal channel. Any device with access to the web can send content to the proxy server 106. Because the interface presented by the proxy server 106 follows standard web conventions, it is expected to be more convenient for third-party applications to send content via the proxy server 106 rather than sending the content directly to the head-end server 104.

In step 502, the proxy server 106 receives a delivery command associated with the content received in step 500. Generally the command is specified by the sender of the content and can state a delivery criterion as discussed above in reference to step 306 of FIG. 3 and step 408 of FIG. 4.

The proxy server 106 checks the content for digital-rights compliance in step 504. In some embodiments, this step complements the checking performed by the recipient head-end server 104.

Because the proxy server 106 exists on the web, while the head-end server 104 exists in a television-delivery environment, the proxy server 106 may need to translate some content in step 506 before that content will be usable to the head-end server 104.

In step 508, the proxy server 106 complies with any delivery criteria associated with the content, to the extent that it is able to do so.

Then in step 510, the proxy server 106 delivers the content to the appropriate head-end server 104, if the content complies with all digital-rights policies.

In view of the many possible embodiments to which the principles of the present invention may be applied, it should be recognized that the embodiments described herein with respect to the drawing figures are meant to be illustrative only and should not be taken as limiting the scope of the invention. For example, the personal channel can accept different media types than the ones discussed here. Therefore, the invention as described herein contemplates all such embodiments as may come within the scope of the following claims and equivalents thereof.

We claim:

1. In a multi-channel television environment, a method for a head-end server to deliver media content to a recipient client device via a personal television channel, the method comprising:
establishing, by the head-end server, the personal television channel;
creating, by the head-end server, a playlist for the personal television channel;
receiving, by the head-end server from a proxy server, media content for the personal television channel;
receiving, by the head-end server from the recipient client device, a channel-selection command for the personal television channel;
sending, by the head-end server to the recipient client device, the playlist; and
sending, by the head-end server to the recipient client device, at least a portion of a first media presentation on the playlist.

2. The method of claim 1 wherein receiving media content comprises receiving, by the head-end server from the proxy server, a delivery criterion for the received media content, the delivery criterion selected from the group consisting of: do not deliver before a specified time, delete after a specified time, delete after a specified period after an initial delivery, deliver no more often than a specified number of times, only deliver when a context of the recipient client device satisfies a specified criterion, and assign a specified priority level to delivery.

3. The method of claim 1 further comprising:
sending, by the head-end server to the recipient client device, an application for presenting the playlist to the user of the recipient client device.

4. The method of claim 1 further comprising:
checking, by the head-end server, media content for the personal television channel for digital-rights compliance.

5. The method of claim 1 further comprising:
adding, by the head-end server, media content to the playlist.

6. The method of claim 1 further comprising:
sending, by the head-end server to the recipient client device, at least some media content for the personal television channel by trickle casting.

7. The method of claim 6 wherein the trickle-casted content is delivered via an connection selected from the group consisting of: a dedicated network channel, a broadcast channel, a time-shared network connection, and an Internet-protocol channel.

8. A head-end server configured for delivering media content to a recipient client device via a personal television channel in a multi-channel environment, the head-end server comprising:
a transceiver configured for receiving, from a proxy server, media content for the personal television channel; and
a processor operatively connected to the transceiver and configured for:
establishing the personal television channel;
creating a playlist for the personal television channel;
receiving, via the transceiver from the recipient client device, a channel-selection command for the personal television channel;
sending, to the recipient client device, the playlist; and
sending, to the recipient client device, at least a portion of a first media presentation on the playlist.

9. The head-end server of claim 8 wherein the head-end server is selected from the group consisting of: a server and a coordinated group of servers.

10. In a multi-channel television environment, a method for a first client device to deliver media content to a user of the first client device via a personal television channel, the method comprising:
selecting, by the first client device, the personal television channel;
sending, by the first client device to a head-end server, a channel-selection command for the personal television channel;
receiving, by the first client device from the head-end server, a playlist for the personal television channel;
presenting, by the first client device to a user of the first client device, at least a portion of the playlist; and
if a command is received associated with the playlist, then performing, by the first client device, the received command;
else:
receiving, by the first client device from the head-end server, a first media presentation on the playlist; and
rendering the first media presentation to the user of the first client device.

11. The method of claim 10 wherein selecting the personal television channel is performed in response to a command entered by the user of the first client device, the command selected from the group consisting of: tune to a specified channel number of the personal television channel, select the personal television channel from within an electronic program guide, and select a pop-up widget associated with the personal television channel.

12. The method of claim 10 wherein presenting the playlist comprises presenting locally-stored content on the playlist.

13. The method of claim 10 where the command is selected from the group consisting of: set a filter on received content, set a delivery priority, set a delivery time, enable random-play delivery, bind together two instances of received media content, delete media content, re-arrange media content, and set an interruptibility criterion.

14. The method of claim 10 further comprising:
receiving, by the first client device from the head-end server, an application for presenting the playlist to the user of the first client device.

15. The method of claim 10 further comprising:
receiving, by the first client device from the user of the first client device, a command to send media content to a recipient client device; and
sending, by the first client device to a proxy server, the media content and a recipient address.

16. The method of claim 10 further comprising:
receiving, by the first client device from the user of the first client device, a command to send media content to a recipient client device distinct from the first client device; and
sending, by the first client device to the recipient client device, the media content.

17. The method of claim 10 further comprising:
receiving, by the first client device from a second client device distinct from the first client device, media content; and
adding, by the first client device, the received media content to the playlist for the personal television channel.

18. A first client device configured for delivering media content to a user of the first client device via a personal television channel in a multi-channel television environment, the first client device comprising:
a transceiver; and
a processor operatively connected to the transceiver and configured for:
selecting the personal television channel;
sending, via the transceiver to a head-end server, a channel-selection command for the personal television channel;
receiving, via the transceiver from the head-end server, a playlist for the personal television channel;
presenting, to a user of the first client device, at least a portion of the playlist; and
if a command is received associated with the playlist, then performing the received command;
else:
receiving, via the transceiver from the head-end server, a first media presentation on the playlist; and
rendering the first media presentation to the user of the first client device.

19. The first client device of claim 18 wherein the first client device is selected from the group consisting of: a set-top box and a personal computer.

20. In a multi-channel television environment, a method for a proxy server to deliver media content to a head-end server for a personal television channel, the method comprising:
receiving, by the proxy server, first media content addressed to a recipient client device; and
sending, by the proxy server to a head-end server associated with the recipient client device, the received first media content.

21. The method of claim 20 wherein the first media content is received from a sender client device.

22. The method of claim 21 wherein the sender and receiver client devices are the same device.

23. The method of claim 20 wherein receiving comprises receiving a delivery criterion for the first media content, the delivery criterion selected from the group consisting of: do not deliver before a specified time, delete after a specified time, delete after a specified period after an initial delivery, deliver no more often than a specified number of times, only deliver when a context of the recipient client device satisfies a specified criterion, and assign a specified priority level to delivery.

24. The method of claim 20 further comprising:
receiving, by the proxy server, second media content from a server distinct from the proxy server and addressed to the recipient client device; and
sending, by the proxy server to the head-end server associated with the recipient client device, the received second media content.

25. The method of claim 20 further comprising:
translating, by the proxy server, the received first media content into a different format before sending to the head-end server.

26. The method of claim 20 further comprising:
receiving, by the proxy server from a user associated with the recipient client device, a command; and
performing, by the proxy server, the received command;
wherein the command is selected from the group consisting of: set a filter on received content, set a delivery priority, set a delivery time, enable random-play delivery, bind together two instances of received media content, delete media content, and re-arrange media content.

27. A proxy server configured for delivering media content to a head-end server for a personal television channel in a multi-channel television environment, the client device comprising:
a transceiver configured for receiving first media content addressed to a recipient client device; and
a processor operatively connected to the transceiver and configured for:
sending, via the transceiver to a head-end server associated with the recipient client device, the received first media content.

28. The proxy server of claim 27 wherein the proxy server is selected from the group consisting of: a server and a coordinated group of servers.
